(19) United States
(12) Patent Application Publication
(10) Pub. No.: US 2018/0223672 A1
(43) Pub. Date: Aug. 9, 2018

(54) INVESTMENT CASTING CORE

(71) Applicant: General Electric Company, Schenectady, NY (US)

(72) Inventors: Matthew Thomas Beyer, West Chester, OH (US); Tingfan Pang, West Chester, OH (US)

(21) Appl. No.: 15/426,318

(22) Filed: Feb. 7, 2017

(51) Int. Cl. F01D 5/18; B22C 7/02; B22C 9/10; B22C 9/24; B22D 25/02; B22D 29/00; B23P 15/02; B23B 35/00

(52) U.S. Cl. CPC F01D 5/186; B22C 7/02; B22C 9/10; B22C 9/24; F05D 2240/304; B22D 29/002; B23P 15/02; B23B 35/00; B22D 25/02

(57) ABSTRACT

An apparatus and method for an investment casting core for forming a cast airfoil extending between a leading edge and a trailing edge to define a chord-wise direction and extending between a root and a tip to define a span-wise direction, with an internal passage including at least one leach hole formed from the investment casting core.

### BACKGROUND OF THE INVENTION

Turbine engines, and particularly gas or combustion turbine engines, are rotary engines that extract energy from a flow of combusted gases passing through the engine onto a multitude of rotating turbine blades.

Turbine blade assemblies include the turbine airfoil or blade, a platform and a dovetail mounting portion. The turbine blade assembly includes cooling inlet passages as part of serpentine circuits in the platform and blade used to cool the platform and blade.

Investment casting is utilized to manufacture the serpentine circuits by developing an investment casting core. Fillets between the passages and supporting features of the core can create high stress points and increase the risk of breaking during the investment casting process. It is therefore desirable to develop connections with larger fillet radii.

### BRIEF DESCRIPTION OF THE INVENTION

In one aspect, the present disclosure relates to an investment casting core for forming a cast airfoil extending between a leading edge and a trailing edge to define a chord-wise direction and extending between a root and a tip to define a span-wise direction, with an internal passage terminating in a leach hole, comprising at least one interior core defining the internal passage, at least one leach core extending from at least one interior core to define a leach hole in the trailing edge of the airfoil.

In another aspect, the present disclosure relates to a method for forming cooling holes in a trailing edge of an airfoil, the method comprising casting the airfoil with an internal passage and at least one leach hole from the internal passage to the trailing edge, drilling trailing edge film holes in the trailing edge using the at least one leach hole as a pilot hole, and converting the leach hole to a trailing edge film hole after the drilling.

In another aspect, the present disclosure relates to an investment casting core for forming an engine component having a trailing edge with an internal passage terminating in a leach hole, comprising at least one interior core defining the internal passage, at least one leach core extending from the at least one interior core to define a leach hole in the trailing edge of the engine component.

### BRIEF DESCRIPTION OF THE DRAWINGS

In the drawings:

FIG. 1 is a schematic cross-sectional diagram of a gas turbine engine for an aircraft.

FIG. 2 is a perspective view of a turbine blade assembly for the gas turbine engine of FIG. 1 including internal passages illustrated in phantom.

FIG. 3 is a perspective view of the turbine blade assembly shown in phantom with an investment casting core according to a first aspect of the disclosure described herein.

FIG. 4A is a cross-sectional view of the investment casting core of FIG. 3 during an investment casting process.

FIG. 4B is a cross-sectional view of the investment casting core of FIG. 3 after FIG. 4A during the investment casting process.

FIG. 4C is a cross-sectional view of the investment casting core of FIG. 3 after FIG. 4B during the investment casting process.

FIG. 5 is schematic illustration of a drill and a trailing edge of an airfoil of the turbine blade assembly of FIG. 3.

FIG. 6 is a partial cut-away of the turbine blade assembly of FIG. 3 upon completion of drilling.

FIG. 7 is a cross-sectional view of the investment casting core of FIG. 2 according to a first aspect of the disclosure described herein.

FIG. 8 is a cross-sectional view of the investment casting core of FIG. 2 according to a second aspect of the disclosure described herein.

FIG. 9 is a cross-sectional view of the investment casting core of FIG. 2 according to a third aspect of the disclosure described herein.

### DETAILED DESCRIPTION OF THE INVENTION

Aspects of the disclosure described herein are directed to the placement of leach holes in a trailing edge of a an investment casting core for an investment casting process in the development of internal passages as part of a cooling circuit for an airfoil in a turbine blade assembly. For purposes of illustration, the present disclosure will be described with respect to the turbine for an aircraft gas turbine engine. It will be understood, however, that aspects of the disclosure described herein are not so limited and may have general applicability within an engine, including compressors, as well as in non-aircraft applications, such as other mobile applications and non-mobile industrial, commercial, and residential applications.

As used herein, the term “forward” or “upstream” refers to moving in a direction toward the engine inlet, or a component being relatively closer to the engine inlet as compared to another component. The term “aft” or “downstream” used in conjunction with “forward” or “upstream” refers to a direction toward the rear or outlet of the engine or being relatively closer to the engine outlet as compared to another component.

Additionally, as used herein, the terms “radial” or “radially” refer to a dimension extending between a center longitudinal axis of the engine and an outer engine circumference.

All directional references (e.g., radial, axial, proximal, distal, upper, lower, upward, downward, left, right, lateral, front, back, top, bottom, above, below, vertical, horizontal, clockwise, counterclockwise, upstream, downstream, forward, aft, etc.) are only used for identification purposes to aid the reader's understanding of the present disclosure, and do not create limitations, particularly as to the position, orientation, or use of aspects of the disclosure described herein. Connection references (e.g., attached, coupled, connected, and joined) are to be construed broadly and can include intermediate members between a collection of elements and relative movement between elements unless otherwise indicated. As such, connection references do not necessarily infer that two elements are directly connected and in fixed relation to one another. The exemplary drawings are for purposes of illustration only and the dimensions, positions, order and relative sizes reflected in the drawings attached hereto can vary.

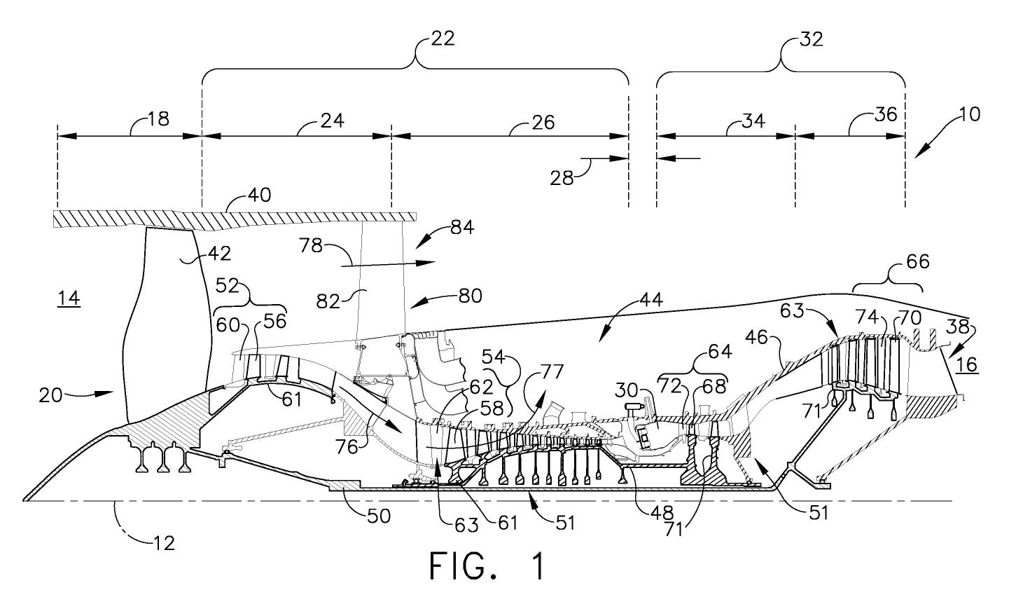

FIG. 1 is a schematic cross-sectional diagram of a gas turbine engine 10 for an aircraft. The engine 10 has a generally longitudinally extending axis or centerline 12 extending forward 14 to aft 16. The engine 10 includes, in downstream serial flow relationship, a fan section 18 including a fan 20, a compressor section 22 including a booster or low pressure (LP) compressor 24 and a high pressure (HP) compressor 26, a combustion section 28 including a combustor 30, a turbine section 32 including a HP turbine 34, and a LP turbine 36, and an exhaust section 38.

The fan section 18 includes a fan casing 40 surrounding the fan 20. The fan 20 includes a plurality of fan blades 42 disposed radially about the centerline 12. The HP compressor 26, the combustor 30, and the HP turbine 34 form a core 44 of the engine 10, which generates combustion gases. The core 44 is surrounded by core casing 46, which can be coupled with the fan casing 40.

A HP shaft or spool 48 disposed coaxially about the centerline 12 of the engine 10 drivingly connects the HP turbine 34 to the HP compressor 26. A LP shaft or spool 50, which is disposed coaxially about the centerline 12 of the engine 10 within the larger diameter annular HP spool 48, drivingly connects the LP turbine 36 to the LP compressor 24 and fan 20. The spools 48, 50 are rotatable about the engine centerline and couple to a plurality of rotatable elements, which can collectively define a rotor 51.

The LP compressor 24 and the HP compressor 26 respectively include a plurality of compressor stages 52, 54, in which a set of compressor blades 56, 58 rotate relative to a corresponding set of static compressor vanes 60, 62 (also called a nozzle) to compress or pressurize the stream of fluid passing through the stage. In a single compressor stage 52, 54, multiple compressor blades 56, 58 can be provided in a ring and can extend radially outwardly relative to the centerline 12, from a blade platform to a blade tip, while the corresponding static compressor vanes 60, 62 are positioned upstream of and adjacent to the rotating blades 56, 58. It is noted that the number of blades, vanes, and compressor stages shown in FIG. 1 were selected for illustrative purposes only, and that other numbers are possible.

The blades 56, 58 for a stage of the compressor can be mounted to a disk 61, which is mounted to the corresponding one of the HP and LP spools 48, 50, with each stage having its own disk 61. The vanes 60, 62 for a stage of the compressor can be mounted to the core casing 46 in a circumferential arrangement.

The HP turbine 34 and the LP turbine 36 respectively include a plurality of turbine stages 64, 66, in which a set of turbine blades 68, 70 are rotated relative to a corresponding set of static turbine vanes 72, 74 (also called a nozzle) to extract energy from the stream of fluid passing through the stage. In a single turbine stage 64, 66, multiple turbine blades 68, 70 can be provided in a ring and can extend radially outwardly relative to the centerline 12, from a blade platform to a blade tip, while the corresponding static turbine vanes 72, 74 are positioned upstream of and adjacent to the rotating blades 68, 70. It is noted that the number of blades, vanes, and turbine stages shown in FIG. 1 were selected for illustrative purposes only, and that other numbers are possible.

The blades 68, 70 for a stage of the turbine can be mounted to a disk 71, which is mounted to the corresponding one of the HP and LP spools 48, 50, with each stage having a dedicated disk 71. The vanes 72, 74 for a stage of the compressor can be mounted to the core casing 46 in a circumferential arrangement.

Complementary to the rotor portion, the stationary portions of the engine 10, such as the static vanes 60, 62, 72, 74 among the compressor and turbine section 22, 32 are also referred to individually or collectively as a stator 63. As such, the stator 63 can refer to the combination of non-rotating elements throughout the engine 10.

In operation, the airflow exiting the fan section 18 is split such that a portion of the airflow is channeled into the LP compressor 24, which then supplies pressurized air 76 to the HP compressor 26, which further pressurizes the air. The pressurized air 76 from the HP compressor 26 is mixed with fuel in the combustor 30 and ignited, thereby generating combustion gases. Some work is extracted from these gases by the HP turbine 34, which drives the HP compressor 26. The combustion gases are discharged into the LP turbine 36, which extracts additional work to drive the LP compressor 24, and the exhaust gas is ultimately discharged from the engine 10 via the exhaust section 38. The driving of the LP turbine 36 drives the LP spool 50 to rotate the fan 20 and the LP compressor 24.

A portion of the pressurized airflow 76 can be drawn from the compressor section 22 as bleed air 77. The bleed air 77 can be drawn from the pressurized airflow 76 and provided to engine components requiring cooling. The temperature of pressurized airflow 76 entering the combustor 30 is significantly increased. As such, cooling provided by the bleed air 77 is necessary for operating of such engine components in the heightened temperature environments.

A remaining portion of the airflow 78 bypasses the LP compressor 24 and engine core 44 and exits the engine assembly 10 through a stationary vane row, and more particularly an outlet guide vane assembly 80, comprising a plurality of airfoil guide vanes 82, at the fan exhaust side 84. More specifically, a circumferential row of radially extending airfoil guide vanes 82 are utilized adjacent the fan section 18 to exert some directional control of the airflow 78.

Some of the air supplied by the fan 20 can bypass the engine core 44 and be used for cooling of portions, especially hot portions, of the engine 10, and/or used to cool or power other aspects of the aircraft. In the context of a turbine engine, the hot portions of the engine are normally downstream of the combustor 30, especially the turbine section 32, with the HP turbine 34 being the hottest portion as it is directly downstream of the combustion section 28. Other sources of cooling fluid can be, but are not limited to, fluid discharged from the LP compressor 24 or the HP compressor 26.

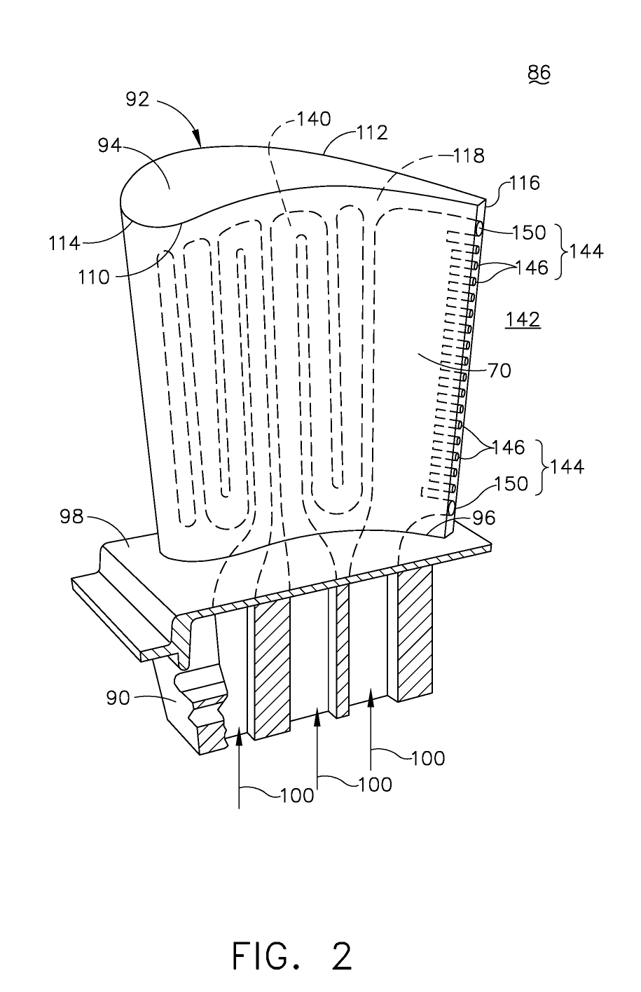

FIG. 2 is a perspective view of a turbine blade assembly 86 with an engine component in particular a turbine blade 70 of the engine 10 from FIG. 1. Alternatively, the engine component can include a vane, a shroud, or a combustion liner in non-limiting examples, or any other engine component that can require or utilize cooling passages formed from an investment casting process and having a trailing edge element.

The turbine blade assembly 86 includes a dovetail 90 and an airfoil 92. The airfoil 92 extends between a tip 94 and a root 96 to define a span-wise direction. The airfoil 92 mounts to the dovetail 90 on a platform 98 at the root 96. The platform 98 helps to radially contain the turbine engine mainstream air flow. The dovetail 90 can be configured to mount to the turbine rotor disk 71 on the engine 10. The dovetail 90 further includes at least one inlet passage 100, exemplarily shown as three inlet passages 100, each extending through the dovetail 90 to provide internal fluid communication with the airfoil 92. It should be appreciated that the dovetail 90 is shown in cross-section, such that the inlet passages 100 are housed within the body of the dovetail 90.

The airfoil 92 includes a concave-shaped pressure sidewall 110 and a convex-shaped suction sidewall 112 which are joined together to define an airfoil shape extending between a leading edge 114 and a trailing edge 116 to define a chord-wise direction. The airfoil 92 has an interior 118 defined by the sidewalls 110, 112. An internal passage 140 can be fluidly coupled with at least one of inlet passages 100. The internal passage 140 can be multiple internal passages. The internal passage 140 along the trailing edge can be fluidly coupled to an exterior 142 of the blade 70 with at least one through-hole 144. The through-holes 144 can be cooling or film holes in the form of trailing edge film holes 146. In an aspect of the disclosure described herein at least one of the through-holes 144 has a larger diameter (150) than the proximate trailing edge film holes 146. FIGS. 1 and 2 illustrate an environment in which the disclosure described herein is applicable. The airfoil 92 of FIG. 2 as an exemplary airfoil that can be made with an investment casting process.

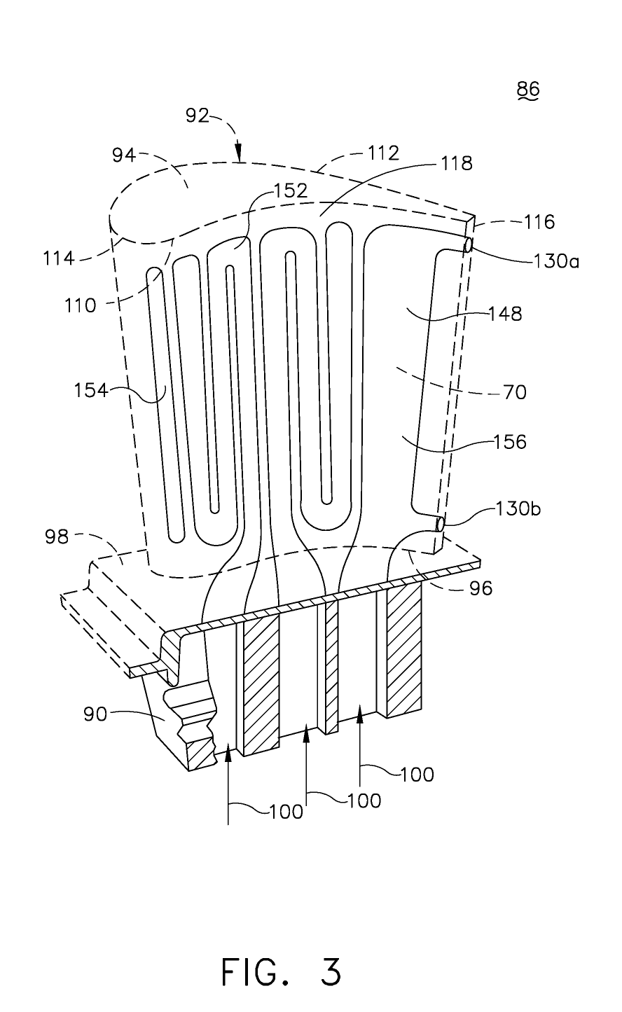

Referring now to FIG. 3, an investment casting core 148 used in forming the internal passages 140 of the airfoil 92 includes at least one leach core 130. The investment casting core 148 is formed, in one non-limiting example, from a ceramic material. The investment casting core 148, when removed, form the passages 140, located within the interior 118 of the airfoil 92, which is shown in dashed lines for clarity of the location of the investment casting core 148.

The investment casting core 148 can further include an interior core, by way of non-limiting example, a serpentine feature 152, a leading edge feature 154, and a trailing edge feature 156. In particular, the trailing edge feature 156 can include multiple leach cores 130a, 130b. One leach core 130a can be located proximate the tip 94 along the trailing edge 116 and another leach core 130b can be located proximate the root 96 along the trailing edge 116. Prior to the investment casting process the investment casting core 148 is cast and can include the trailing edge feature 156 and leach cores 130a, 130b as described. The trailing edge feature 156 is formed from a leachable material which can include, but is not limited to, a ceramic material 162.

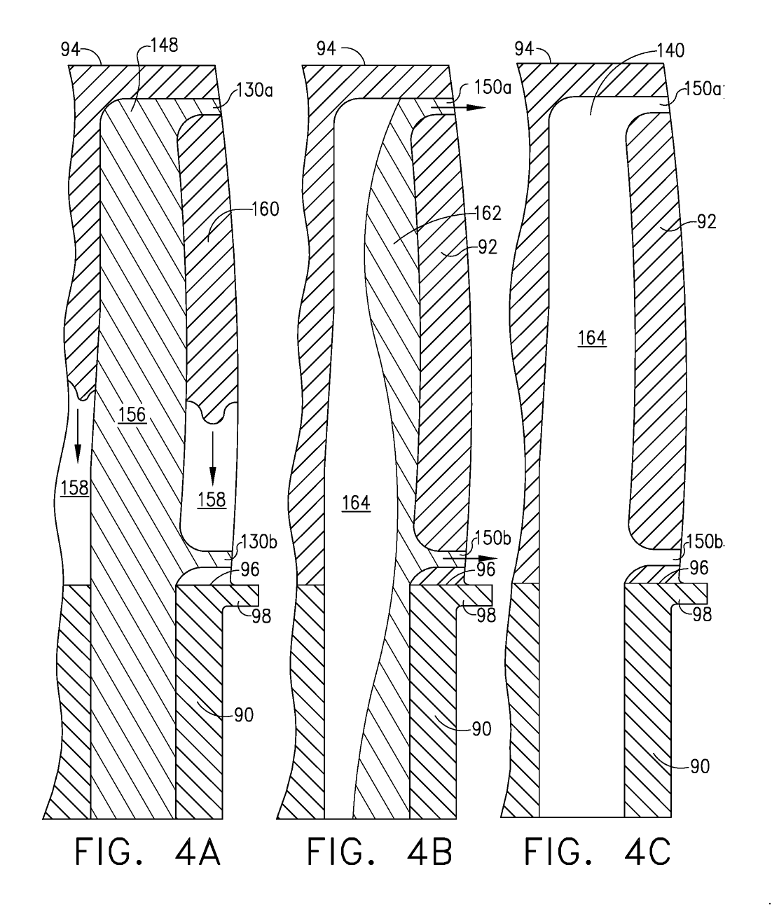

FIG. 4A is a cross section of the trailing edge feature 156 of the investment casting core 148. FIGS. 4B and 4C are cross-sections of the airfoil 92. Together FIG. 4A, FIGS. 4B and 4C illustrate the progression of the investment casting process for the trailing edge feature 156.

Turning to FIG. 4A, during the investment casting process one or more molds enclose the investment casting core 148 to define voids 158 between the molds and the investment casting core 148. To cast the airfoil 92, molten material 160, such as a metal alloy, is introduced into the voids 158 and cooled to form the cast airfoil 92.

In FIG. 4B, the cast airfoil 92 is formed and the investment casting core 148 is removed by leaching. Leach cores 130a, 130b are positioned to ensure all the ceramic material 162 is removed. The leach cores 130a, 130b liquefy and transition to cast leach holes, or simply leach holes, 150a, 150b during the leaching process. The ceramic material 162 used to form the investment casting core 148 is liquefied, in one non-limiting example by heating, and drained out through the leach holes 150a, 150b.

Finally in FIG. 4C a hollow portion 164 is left behind where the investment casting core 148 was to form the internal passages 140. Thus, the investment casting core 148 is a solid representation of the internal passages 140 that will be present in the airfoil 92 upon completion.

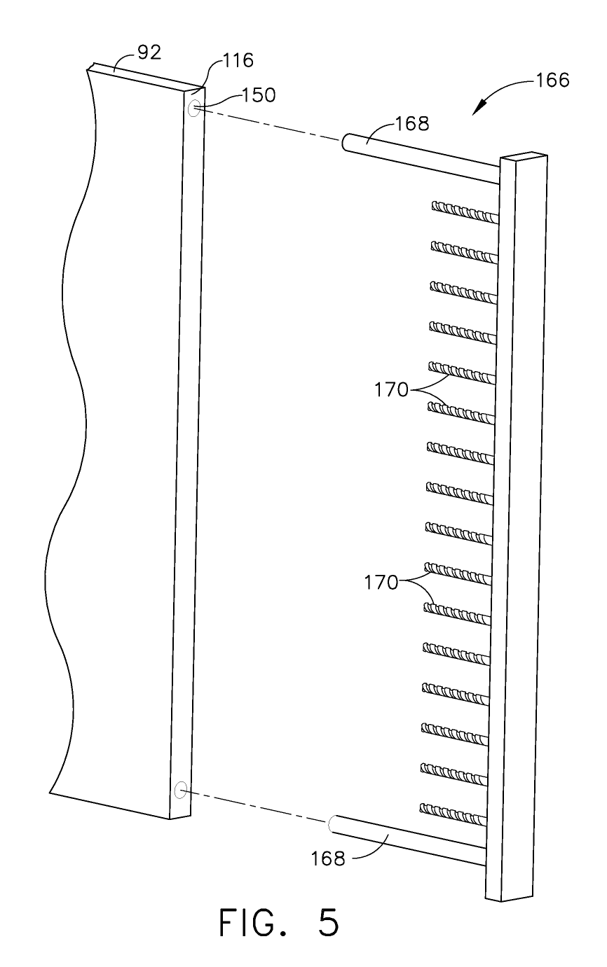

FIG. 5 is a schematic illustration of a drill 166 and the trailing edge 116 of the airfoil 92. The leach holes 150 serve as pilot holes or reference points for drilling the trailing edge film holes 146 at correct locations to ensure a connection between the exterior 142 and the internal passage 140. The trailing edge film holes 146 can be drilled separately or simultaneously or in groups as illustrated. By way of non-limiting example, a drill 166 is illustrated as having at least one guide post 168 and at least one drill bit 170. The at least one guide post 168 is formed to fit into the leach holes 150 so that the film holes 146 can be drilled with the at least one drill bit 170 to ensure optimal placement of the film holes 156 at the trailing edge 116 of the airfoil 92.

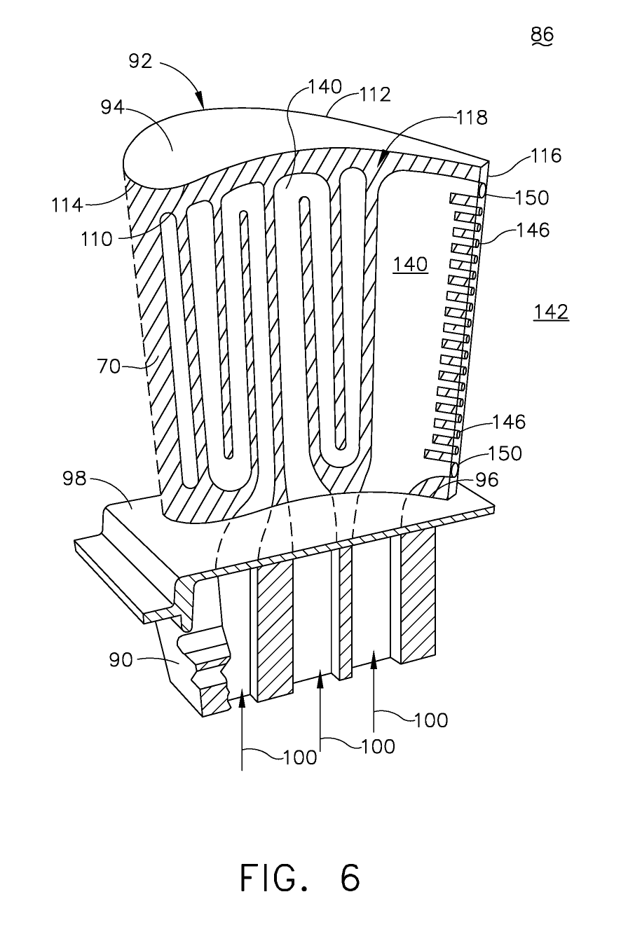

Turning to FIG. 6 a method for forming trailing edge film holes 146 in the trailing edge 116 of the airfoil 92 is illustrated. Casting the airfoil 92 includes forming the internal passages 140 and at least one leach hole 150 extending from the internal passage 140 to the trailing edge 116 as described herein. Trailing edge film holes 146 are then drilled from the trailing edge 116 through to the internal passage 140.

The trailing edge film holes 146 are designed for cooling the trailing edge 116 of the airfoil 92, while the leach holes 150 are formed and positioned to ensure optimal placement of the trailing edge film holes 146 along with the aforementioned leaching of the ceramic material 162. Upon serving as pilot holes, the leach holes 150 are converted to additional cooling holes.

The trailing edge film holes 146 can each have a diameter of less than 0.025 in (0.062 cm). The cross section of the leach holes 150 can be optimized for stress, producibility, leachability, or heat transfer performance. The leach holes 150 can each have a span-wise dimension of 0.01 to 0.06 in (0.02-0.15 cm), and a width dimension of 0.01 to 0.03 in (0.02-0.08 cm). If circular, the leach holes 150 can each have a diameter of 0.010 to 0.050 inches. The leach holes are not limited to circular or elliptical shapes and can be any applicable shape having a maximum cross-section dimension of 0.06 in (0.15 cm).

The leach holes 150 as described herein act as trailing edge film holes 146 during the operation of the airfoil 92. The dimensional differences between the leach holes 150 and the trailing edge film holes 146 can partially influence how effective the leach holes 150 are at cooling the trailing edge 116. The size of the leach holes controls the cooling flow delivered to the trailing edge 116 area, and can be used along with the trailing edge film holes 146 to optimize thermal distribution at the trailing edge 116.

It is further contemplated that upon completion of drilling the trailing edge holes 146, the leach holes 150 are filled in with a metal alloy. A trailing edge film hole 146 with an optimal diameter for cooling can be drilled into the filled area.

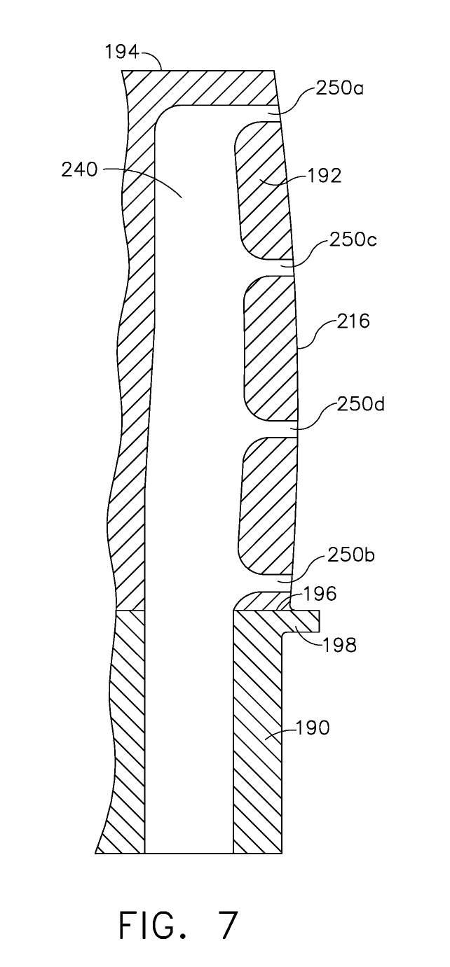

FIGS. 7, 8, and 9 illustrate alternative internal passages 240, 340, 440 and alternative configurations of the passages. It should be understood that the internal passages described herein are formed from investment casting cores similar to the investment casting core 148 described herein and therefore the alternative individual casting cores are also explained using the illustrated internal passages 240, 340, 440. The alternative internal passages 240, 340, 440 are similar in function to the exemplary internal passage 140 illustrated in FIGS. 4A, 4B, 4C, therefore like parts will be identified with like numerals increased by 100, 200, and 300 respectfully. It should be understood that the description of the like parts of the first internal passage 140 applies to the other internal passages 240, 340, 440, unless otherwise noted.

Turning to FIG. 7 another arrangement of leach holes 250a, 250b, 250c, 250d is contemplated. To ensure leaching of all of the ceramic material, two additional leach holes 250c and 250d can be positioned at equal intervals between leach holes 250a and 250b proximate the tip 194 and root 196 respectively. While illustrated as equal intervals, it is further contemplated that the leach holes 250c and 250d can be positioned at various intervals in optimal locations. Additional spaced leach holes along the trailing edge 216 can also be contemplated. The location and placement of the leach holes 250a, 250b, 250c, 250d for all exemplary arrangements described herein is determined based on a designed placement of the trailing edge films holes 146.

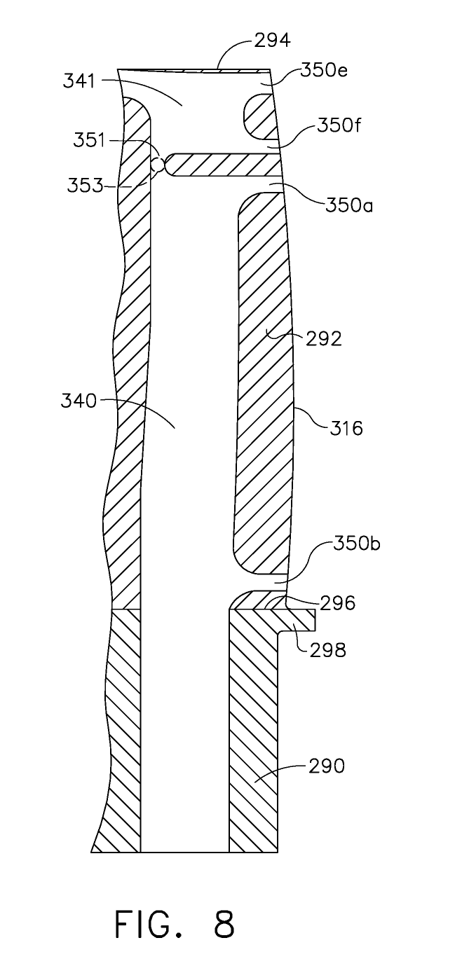

Turning to FIG. 8, another arrangement of leach holes 350a, 350b, 350e and 350f is contemplated. An airfoil 292 includes an additional internal passage 341 proximate the tip 294 of the airfoil 292. The additional internal passage 341 can be fluidly coupled to the internal passage 340 with an internal hole 351. Leach holes 350e and 350f are located at the trailing edge 316 proximate the tip 294 and extend from the additional internal passage 341. It is further contemplated that the additional internal passage 341 is only fluidly connected to the internal passage 340 with the internal hole 351 during the leaching process. After the process is complete a plug, in one non-limiting example a ball 353, can be placed within the internal hole 351 to control subsequent fluid flow within the internal passages 340, 341 during operation of the airfoil 292. It is also contemplated that the internal hole 351 is left open as a flow passage during operation.

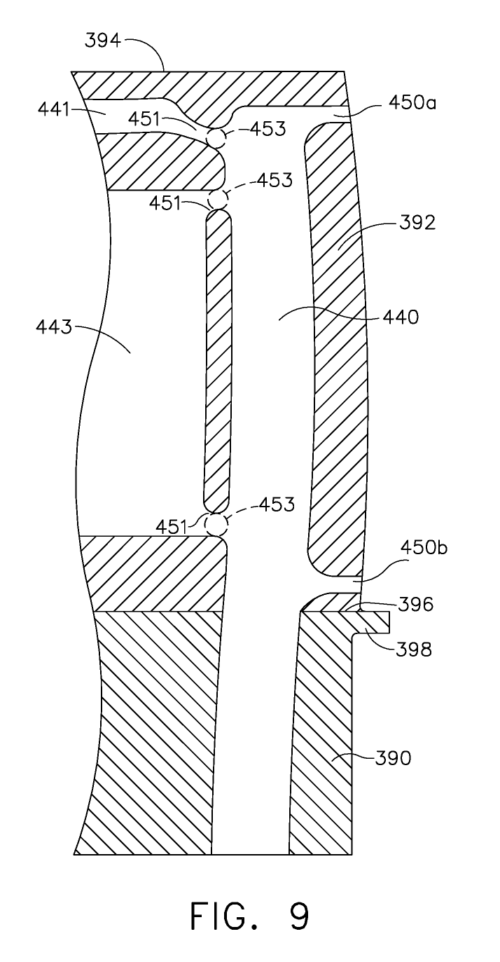

Turning to FIG. 9, another arrangement of leach holes 450a, 450b, is contemplated. An airfoil 392 includes three internal passages 440, 441, and 443. The internal passages 441 and 443 can be fluidly coupled to the internal passage 440 with internal holes 451. During the leaching process, ceramic material can be leached out from the internal passages 443 and 441 through the internal holes 451 and subsequently through the leach holes 450a, 450b. It is further contemplated that the additional internal passages 441, 443 are only fluidly connected to the internal passage 340 with the internal holes 451 during the leaching process. After the process is complete a plug, in one non-limiting example a ball 453, can be placed within one or all of the internal holes 451 to control subsequent fluid flow within the internal passages 440, 441, 443 during operation of the airfoil 392. It is also contemplated that one, some or, all of the internal holes 451 are left open as flow passages during operation.

It should be understood that any combination of an arrangement of leach cores to form the leach holes described herein is also contemplated. Furthermore the internal passages described herein can remain fluidly coupled during operation. The arrangement of leach holes described in the exemplary disclosures herein are for illustrative purposes and not meant to be limiting.

Benefits associated with the arrangement of leach holes 150 discussed herein include optimizing correct placement of trailing edge film holes 146. The correct placement of the trailing edge film holes 146 can increase efficient cooling to the airfoil 92. Compared to current drilling methods, utilizing the leach holes 150 as pilots for drilling the trailing edge film holes 146 decreases the possibility of drilling oversized cooling holes which can occur when attempting to connect the exterior 142 of the airfoil to the internal passages 140. Using the leach holes as reference allows the drilling operation to more reliably hit the internal passages 140 at an intended location. The risk for scarfing along internal walls or hitting high stress spots is minimized by the improved drill accuracy. Also, the likelihood of drilling partially finned or oddly shaped holes is reduced because the drilling operation is more able to locate the internal cavity and drill a clean hole into it.

Elements of the disclosure described herein improve leaching capabilities for casting of an airfoil 92. Placement of the leach cores 130 at areas proximate the tip 94 and root 96 of the airfoil 92 allow for the leach material, or ceramic material as described herein, to flow freely through the hollow area 164 and leave behind smooth internal passages 140. The leach holes 150 allow the ceramic material to flow freely through the hollow area 164 and out of the corners where traditionally core leaching is a challenge. This reduces cycle time and cost, and improves yield.

Cast-in leaching cores 130 give pilot features for the subsequent machining operations that locate and position the internal passages 140. The leaching cores 130 therefore account for variation in the investment casting core 148 location and shape during the casting process. The leach cores 130 move with the investment casting core 148, so the machining operation can compensate for the variation by utilizing the resulting leach holes 150 as reference points. Leach holes 150 are also utilized as shaped cooling holes, providing the ability to have holes with reduced stress concentration. Traditional drilled holes result in sharp edges at the break-out surfaces. Sharp features resulting from the drilling process can be eliminated by implementing the leach cores 130 and subsequent leach holes 150 to serve as pilots for drilling the trailing edge film holes 146. Location of the trailing edge film holes 146 is therefore improved.

Additionally the leach cores serve as a frame to improve the casting core stiffness. In typical investment casting processes, there is excess material that is cast but gets removed for the final intended casting geometry, or “part envelope”. Leach holes 150 allow for core material outside the part envelope to be connected to the internal core. This improves core placement within the part because the core material outside the part envelope can be pinned or fixed in the casting.

Placement of at least one leach hole at the root controls airflow in the internal passages 140 and improves the blade strength based on the engine temperature profile. The leach hole near the root also serves to decrease stress concentration near the airfoil fillet next to the platform of the turbine assembly. Traditional drilled holes result in sharp edges at the break-out surfaces, the surface where the hole enters or exits. The cast-in leach holes can be rounded and optimized to reduce the sharp edge stress concentrations, which is important near highly stressed areas like the blade root. Leach holes may be placed lower than traditional drilled holes could be if optimized for stress, permitting cooling to areas not typically possible with traditional drilling.

It should be appreciated that application of the disclosed design is not limited to turbine engines with fan and booster sections, but is applicable to turbojets and turbo engines as well.

This written description uses examples to describe aspects of the disclosure described herein, including the best mode, and also to enable any person skilled in the art to practice aspects of the disclosure, including making and using any devices or systems and performing any incorporated methods. The patentable scope of aspects of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. An investment casting core for forming a cast airfoil extending between a leading edge and a trailing edge to define a chord-wise direction and extending between a root and a tip to define a span-wise direction, with an internal passage terminating in a leach hole, comprising:
at least one interior core defining the internal passage;
at least one leach core extending from the at least one interior core to define the leach hole in the trailing edge of the airfoil.

2. The investment casting core of claim 1 wherein the at least one leach core comprises multiple leach cores.

3. The investment casting core of claim 1 wherein the at least one leach core is proximate the root.

4. The investment casting core of claim 1 wherein the at least one leach core is proximate the tip.

5. The investment casting core of claim 1 wherein the at least one leach core is between the root and the tip.

6. The investment casting core of claim 1 wherein the at least one interior core comprises multiple interior cores.

7. The investment casting core of claim 6 wherein the at least one leach core comprises multiple leach cores extending from each of the multiple interior cores.

8. The investment casting core of claim 6 wherein the multiple interior cores form multiple interior passages fluidly coupled to each other.

9. The investment casting core of claim 1 wherein the at least one leach core defines a trailing edge hole.

10. The investment casting core of claim 1 wherein the at least one leach core has a maximum cross-section dimension of 0.06 in (0.15 cm).

11. A method for forming cooling holes in a trailing edge of an airfoil, the method comprising:
casting the airfoil with an internal passage and at least one leach hole from the internal passage to the trailing edge; and
drilling trailing edge film holes in the trailing edge using the at least one leach hole as a pilot hole.

12. The method of claim 11 wherein the casting the airfoil further comprises converting the leach hole to a trailing edge film hole after the drilling.

13. The method of claim 12 wherein the converting the leach hole to a trailing edge film hole further comprises filling the leach hole with a metal alloy and drilling a trailing edge film hole through the metal alloy.

14. The method of claim 12 wherein the converting the leach hole to a trailing edge film hole further comprises leaving the leach hole to form a trailing edge film hole larger than the drilled trailing edge film holes.

15. The method of claim 11 wherein the casting the airfoil further comprises forming at least one interior core for the airfoil.

16. The method of claim 15 wherein the casting the airfoil further comprises leaching the interior core through the at least one leach hole.

17. The method of claim 16 wherein the casting the airfoil further comprises casting multiple interior passages.

18. The method of claim 17 wherein the multiple interior passages are fluidly coupled.

19. The method of claim 11 wherein the casting comprises multiple leach holes.

20. The method of claim 19 wherein the drilling comprises using at least two of the multiple leach holes as pilot holes.

21. The method of claim 11 wherein the drilling trailing edge film holes further comprises drilling multiple trailing edge film holes.

22. The method of claim 21 further comprising simultaneously drilling multiple trailing edge film holes.

23. The method of claim 11 wherein the drilling the trailing edge film holes further comprises extending the trailing edge film hole from the trailing edge to the internal passage.

24. An investment casting core for forming an engine component having a trailing edge with an internal passage terminating in a leach hole, comprising:
at least one interior core defining the internal passage;
at least one leach core extending from the at least one interior core to define a leach hole in the trailing edge of the engine component.

25. The investment casting core of claim 24 wherein the at least one leach core comprises multiple leach cores.

26. The investment casting core of claim 24 wherein the at least one interior core comprises multiple interior cores.

27. The investment casting core of claim 26 wherein the multiple leach cores comprises multiple leach cores extending from each of the multiple interior cores.

28. The investment casting core of claim 26 wherein the multiple interior cores form multiple interior passages fluidly coupled to each other.

29. The investment casting core of claim 24 wherein the at least one leach core defines a trailing edge film hole.

30. The investment casting core of claim 24 wherein the at least one leach core has a maximum cross-section dimension of 0.060 in (0.15 cm).

31. An airfoil comprising:
an outer wall bounding an interior and extending between a leading edge and a trailing edge to define a chord-wise direction and extending between a root and a tip to define a span-wise direction;
an internal passage located within the interior and comprising:
at least one cast leach hole extending from the internal passage to the trailing edge of the airfoil, and
at least one drilled trailing edge film hole extending from the internal passage in the trailing edge of the airfoil.

32. The airfoil of claim 31 wherein the at least one drilled trailing edge film hole has a maximum cross-section dimension of 0.025 in (0.064 cm).

33. The airfoil of claim 31 wherein the at least one cast leach hole has a maximum cross-section dimension of 0.060 in (0.15 cm).

34. The airfoil of claim 31 wherein the at least one cast leach hole comprises multiple cast leach holes.

35. The airfoil of claim 31 wherein the at least one cast leach hole is proximate the root.

36. The airfoil of claim 31 wherein the at least one cast leach hole is proximate the tip.

37. The airfoil of claim 31 wherein the at least one cast leach hole is between the root and the tip.

38. The airfoil of claim 31 wherein the at least one internal passage comprises multiple internal passages.

39. The airfoil of claim 38 wherein the at least one cast leach hole comprises multiple cast leach holes extending from each of the multiple internal passages.

40. The airfoil of claim 38 wherein the multiple internal passages fluidly coupled to each other.

41. The airfoil of claim 31 wherein the at least one cast leach hole defines a trailing edge film hole with a different dimension than the drilled trailing edge film hole.
